(19) United States
(12) Patent Application Publication
(10) Pub. No.: US 2018/0132506 A1
(43) Pub. Date: May 17, 2018

(54) PRE-MIX COMPOSITIONS FOR THE MANUFACTURE OF SOFT SERVE PRODUCTS

(71) Applicant: SHAKEUP NUTRITION SOLUTIONS, LLC, Tallahassee, FL (US)

(72) Inventors: Tammar Meiron, Holon (IL); Boaz Maor, Tel-Aviv (IL); Tsachee Zilberfarb, Tallahassee, FL (US)

(21) Appl. No.: 15/422,092

(22) Filed: Feb. 1, 2017

Related U.S. Application Data
(63) Continuation-in-part of application No. 15/141,515, filed on Apr. 28, 2016, now abandoned.

(51) Int. Cl. A23G 9/32; A23G 9/34; A23G 9/40; A23G 9/38

(52) U.S. Cl. CPC A23G 9/32; A23G 9/34; A23V 2002/00; A23G 9/38; A23G 9/40

(57) ABSTRACT

A pre-mix composition that forms a soft serve product, the composition comprising: calories: 80-125 kcal/100 grams of pre-mix; protein: 3-8 g/100 grams of pre-mix; fat: 0.5-2.5 g/100 grams of pre-mix; carbohydrates: 10-40 g/100 grams of pre-mix; sugar 4.5-6.5 g/100 grams of pre-mix; and dietary fiber: 0.5-4.5 g/100 grams of pre-mix; wherein, comprises the taste profile comparable to a reference pre-mix: sweetness (GL1) −70-(−80); bitterness (COO) −72-(−74); richness (CPA (AAE)) −13-(−16); after-taste (AAE) −19-(−20); and (AE1) −18-(−20); saltiness (CTO) −5-(−7) and wherein, the taste profile is measured by the E-tongue test. The pre-mix composition that is made into a soft serve product of the present invention has substantially lower (e.g. 10%, 20%, 30%, 40%, or 50%) calories, fat content and/or sugar level and/or any combination therein when compared to a reference pre-mix composition that is made into a soft serve product. At the same time, the consumer experience of the present invention is at least as good as the reference product (e.g. taste and appearance and mouth feel).

### BACKGROUND

A soft serve product is generally lower in milk-fat (3% to 6%) than reference ice cream (10% to 18%) and is produced at a temperature of about −4° C. compared to ice cream, which is stored at −15° C. Soft serve contains air, introduced at the time of freezing. The air content, called overrun, can vary from 0% to 60% of the total volume of finished product. Conventionally, the amount of air alters the taste and the texture of the finished product. Product with low quantities of air has a heavy, icy taste and appears more yellow. Product with higher air content tastes creamier, smoother and lighter and appears whiter. The optimum quantity of air is determined by the other ingredients and individual taste.

All ice cream must be frozen quickly to avoid crystallization. With soft serve, this is accomplished by a special machine at the point of sale. Pre-mixed product (see definitions below) is introduced to the storage chamber of the machine where it is kept at 3° C. When product is drawn from the draw valve, fresh mix combined with the targeted quantity of air is introduced to the freezing chamber either by gravity or pump. It is then churned and quick frozen and stored until required.

Reference pre-mix product can be obtained by obtaining a fresh liquid that requires constant refrigeration until needed.

### SUMMARY OF THE INVENTION

In one embodiment, the pre-mix composition that is made into a soft serve product of the present invention has substantially lower (e.g. 10%, 20%, 30%, 40%, or 50%) calories (i.e. energy) when compared to a reference pre-mix composition that is made into a soft serve product. At the same time, the consumer experience of the present invention is as at least as good as the reference product (e.g. taste, appearance and mouthfeel).

In another embodiment, the pre-mix composition that is made into a soft serve product of the present invention has substantially lower (e.g. 50%, 60% 70% or 80%) fat content when compared to a reference pre-mix composition that is made into a soft serve product. At the same time, the consumer experience of the present invention is as good as the reference product (e.g. taste, appearance and mouthfeel).

In yet another embodiment, the pre-mix composition that is made into a soft serve product of the present invention has substantially lower (e.g. 40%-80%) sugar level when compared to a reference pre-mix composition that is made into a soft serve product. At the same time, the consumer experience of the present invention is at least as good as the reference product (e.g. taste, appearance and mouthfeel).

In yet another embodiment, the pre-mix composition that is made into a soft serve product of the present invention has substantially lower (e.g. 10%, 20%, 30%, 40%, or 50%) calories, fat content and/or sugar level and/or any combination therein when compared to a reference pre-mix composition that is made into a soft serve product. At the same time, the consumer experience of the present invention is at least as good as the reference product (e.g. taste, stability, appearance and mouthfeel). In another embodiment, the consumer experience of the present invention is better than the reference product (e.g. taste, stability, appearance and mouthfeel).

In one embodiment, the pre-mix composition that forms a soft serve therein, the pre-mix composition comprising: Calories: 80-110 kcal/100 grams of pre-mix; Protein: 3-8 g/100 grams of pre-mix; Fat: 1-2 g/100 grams of pre-mix; Sugar: 4-7 g/100 grams of pre-mix; and Dietary fiber: 1-2 g/100 grams of pre-mix; wherein the taste profile is:

A) Sweetness (GL1) −70-(−80)

B) Bitterness (COO) −72-(−74)

C) Richness (CPA (AAE)) −13-(−16)

D) After-taste (AAE) −19-(−20); and (AE1) −18-(−20)

E) Saltiness (CTO) −5-(−7)

wherein the taste profile is measured by the E-tongue test.

In one embodiment, the pre-mix composition that forms a soft serve therein, the pre-mix composition comprising: Calories: 80-125 kcal/100 grams of pre-mix; Protein: at least 3 g/100 grams of pre-mix; Fat: 0.5-3 g/100 grams of pre-mix; Sugar 4-7 g/100 grams of pre-mix; and Dietary fiber 0.5-5 g/100 grams of pre-mix; wherein the taste profile is:

A) Sweetness (GL1) −70-(−80)

B) Bitterness (COO) −72-(−74)

C) Richness (CPA (AAE)) −13-(−16)

D) After-taste (AAE) −19-(−20); and (AE1) −18-(−20)

E) Saltiness (CTO) −5-(−7)

wherein the taste profile is measured by the E-tongue test, and comparable to a reference soft serve pre-mix taste profile

In another embodiment, the sweetening agent comprises sucralose, polyols, and/or stevia and combinations thereof.

In yet another embodiment, the pre-mix composition that forms a soft serve therein, the pre-mix composition comprising: 72.0% to about 83.0% of milk, 0.1% to about 5.0% of a 38-40% cream, 2.5% to 5.0% of a (0.5% fat) skim milk powder, 0.002% to 0.005% sucralose, 4.0% to 14.0% maltitol, 1.5% to 5.0% maltitol syrup, 0.5% to 3.0% glycerol, 0.00% to 0.25% salt, 0% to 10.5% maltodextrin and starches, 0.0% to 2.5% FOS (such as inulin), 0.1% to 0.5% stabilizers, 0.05% to 0.35% MCC; and

wherein, comprises the taste profile, compatible to a reference formula pre-mix taste profile:

A) Sweetness (GL1) −70-(−80)

B) Bitterness (COO) −72-(−74)

C) Richness (CPA (AAE)) −13-(−16)

D) After-taste (AAE) −19-(−20); and (AE1) −18-(−20)

E) Saltiness (CTO) −5-(−7)

wherein, the taste profile is measured by the E-tongue test.

### DETAILED DESCRIPTION OF THE DRAWINGS

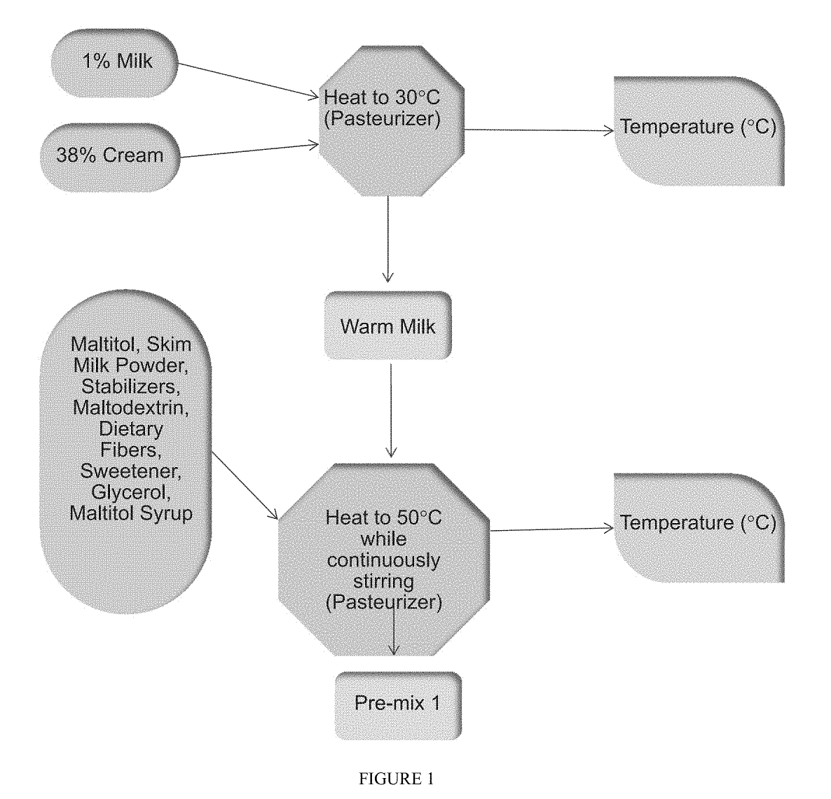

FIG. 1 illustrates one embodiment of the process conditions for preparing the pre-mix of the present invention.

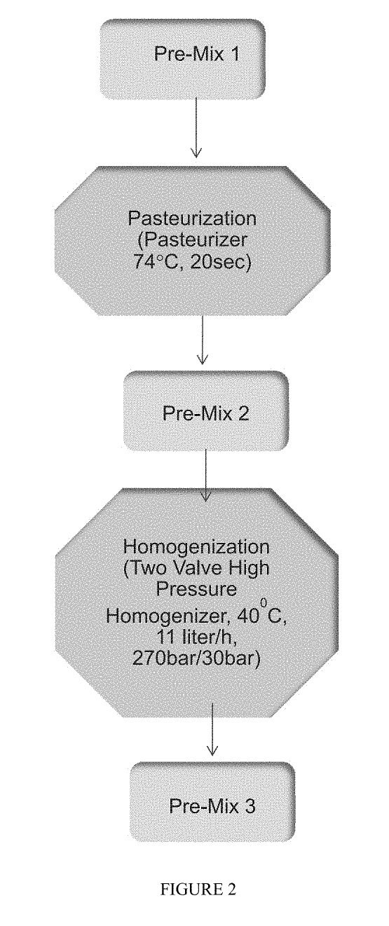

FIG. 2 illustrates one embodiment of the process conditions for preparing the pre-mix of the present invention from the resulting process of FIG. 1.

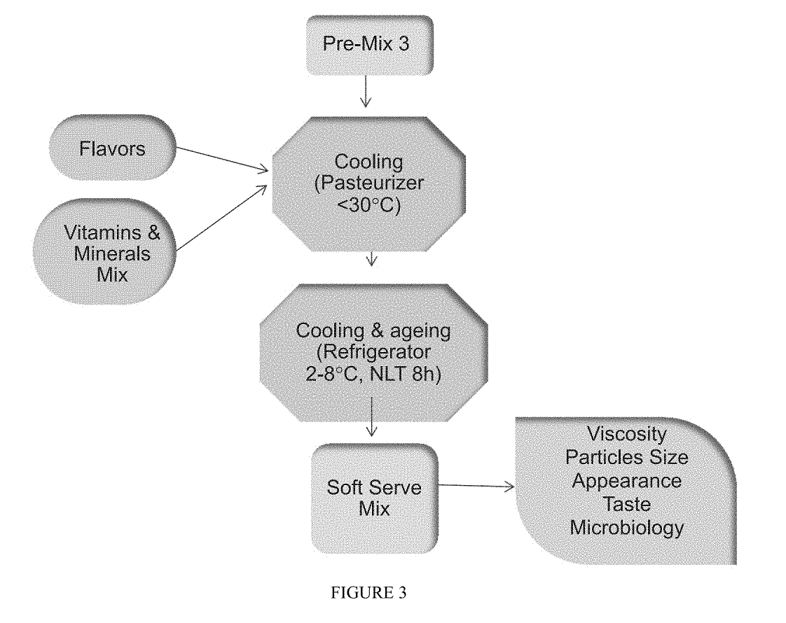

FIG. 3 illustrates one embodiment of the process conditions for preparing the pre-mix of the present invention from the resulting process of FIG. 2.

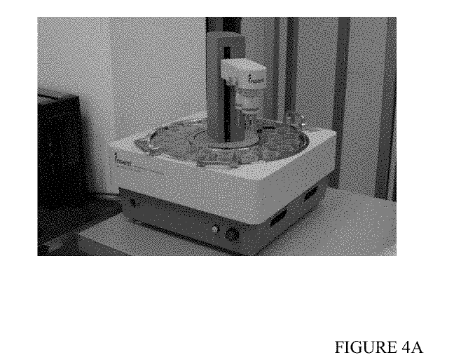

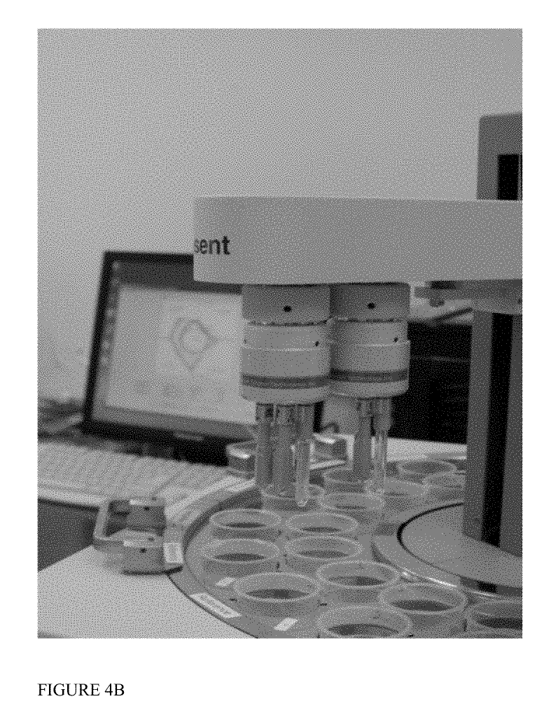

FIGS. 4A and 4B are photographs of the E-tongue used in Example 1.

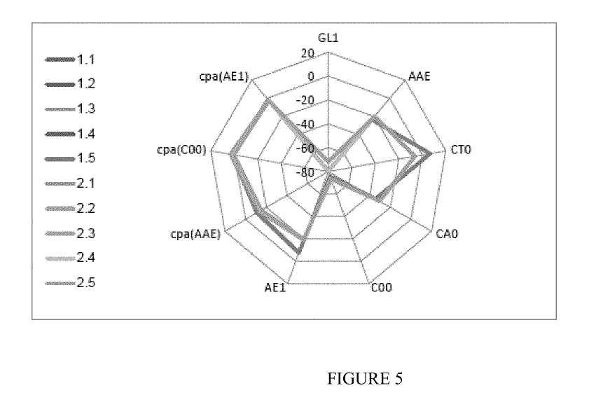

FIG. 5 is a spider web plot showing the comparison between the taste profile of the pre-mix of the present invention compared to the reference pre-mix composition of Example 1.

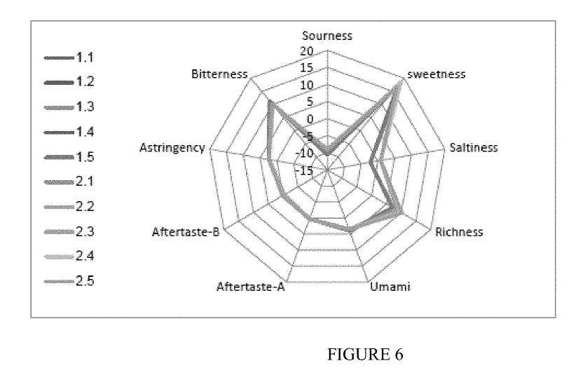

FIG. 6 is the same spider web plot of FIG. 5 showing the comparison between the taste profile of the pre-mix composition of the present invention compared to the reference pre-mix composition with values converted to human sensory intensity scale of Example 1.

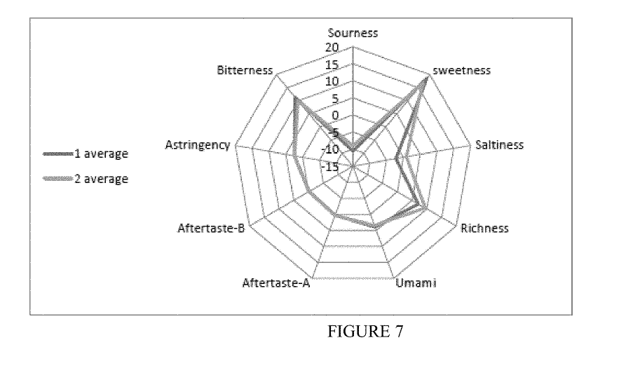

FIG. 7 is the same spider web plot of FIG. 6 showing the comparison between the taste profile of the pre-mix composition of the present invention compared to the reference pre-mix composition with values converted to human sensory intensity scale as averaged between all 5 repetitions of Example 1.

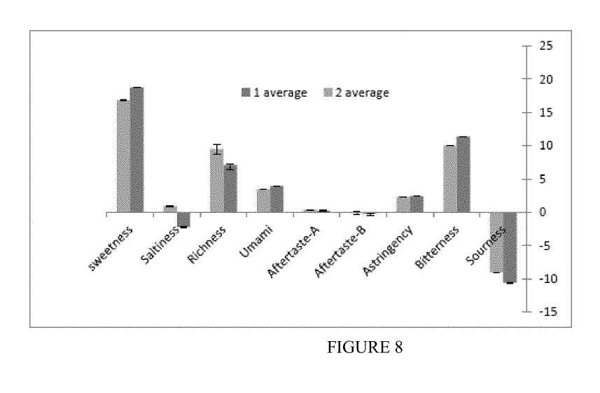

FIG. 8 is the average output showing the comparison between the taste profile of the pre-mix composition of the present invention compared to the reference pre-mix composition with values converted to human sensory intensity scale of Example 1.

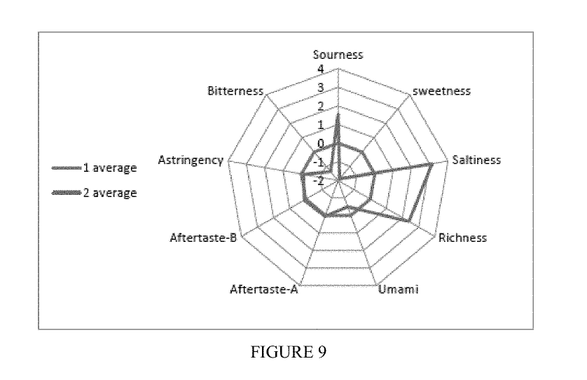

FIG. 9 is the spider web plot showing the average comparison between the taste profile of the pre-mix composition of the present invention compared to the reference pre-mix composition with values converted to human sensory intensity scale of Example 1.

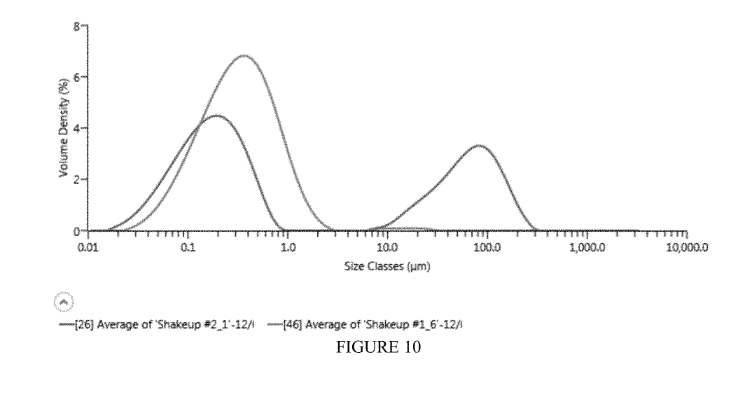

FIG. 10 is the average droplet size distribution curves of the pre-mix of the present invention compared to reference pre-mix of Example 2.

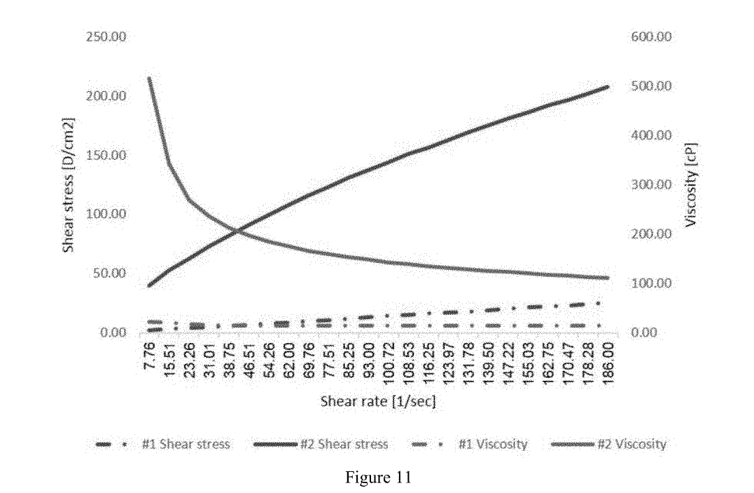

FIG. 11 is the shear stress and viscosity curves of the pre-mix of the present invention compared to reference pre-mix of Example 2.

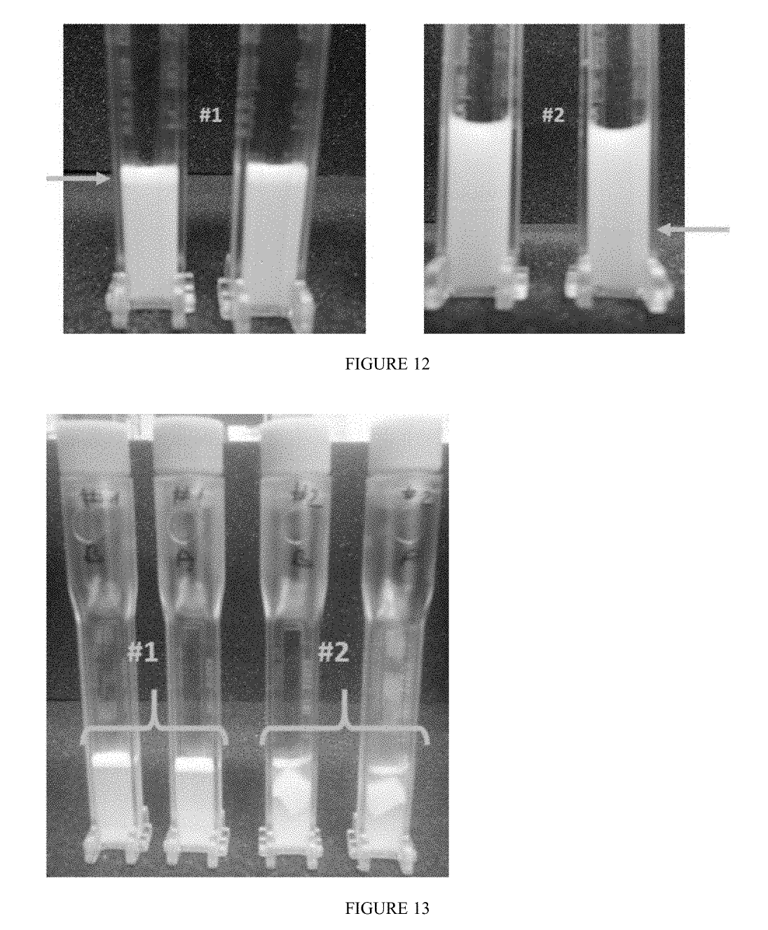

FIG. 12 is the curvettes after stability analysis in Lumisizer instrument for 8 hours at 2000 rpm of the pre-mix of the present invention compared to reference pre-mix of Example 2.

FIG. 13 is the curvettes after stability analysis in Lumisizer instrument for 25 hours at 4000 rpm of the Pre-Mix of the Present Invention Compared to Pre-Mix Made From Reference Pre-Mix of Example 2.

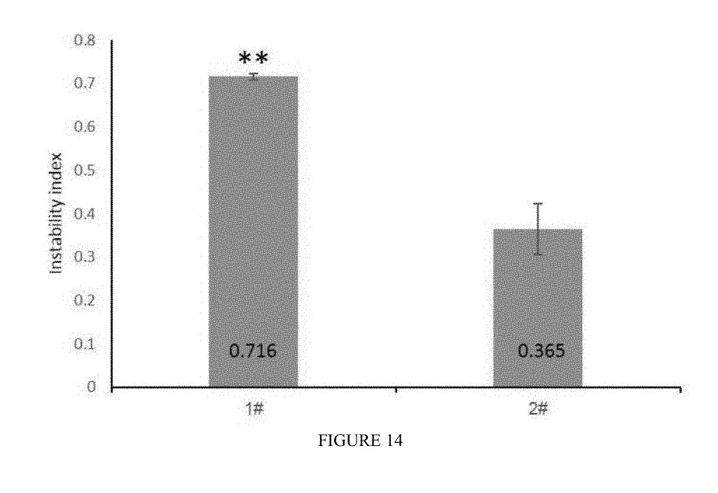

FIG. 14 is the instability index after 25 hours at 4000 rpm of the Pre-Mix of the Present Invention Compared to Reference Pre-Mix of Example 2.

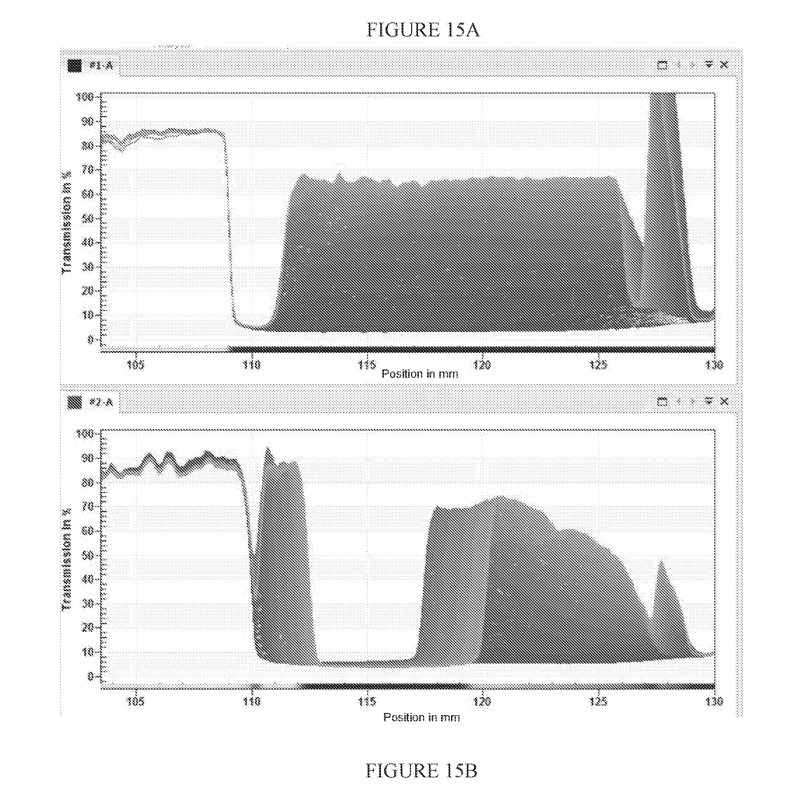

FIGS. 15A and 15B is the space and time extinction profiles recorded during analytical centrifugation of the Pre-Mix of the Present Invention Compared to Reference Pre-Mix of Example 2.

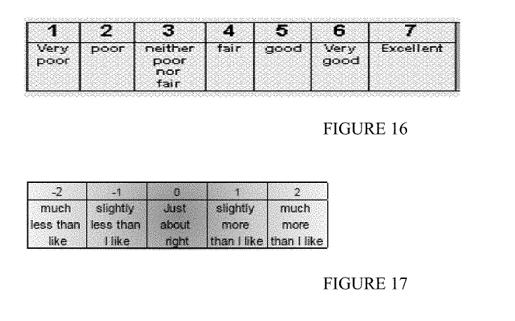

FIG. 16 is the hedonic scale used in Example 3 for the sensory evaluation of soft serve made from pre-mix of the present invention compared to soft serve product made from reference pre-mix.

FIG. 17 is the intensity scale used in Example 3 for the sensory evaluation of soft serve made from pre-mix of the present invention compared to soft serve product made from reference pre-mix.

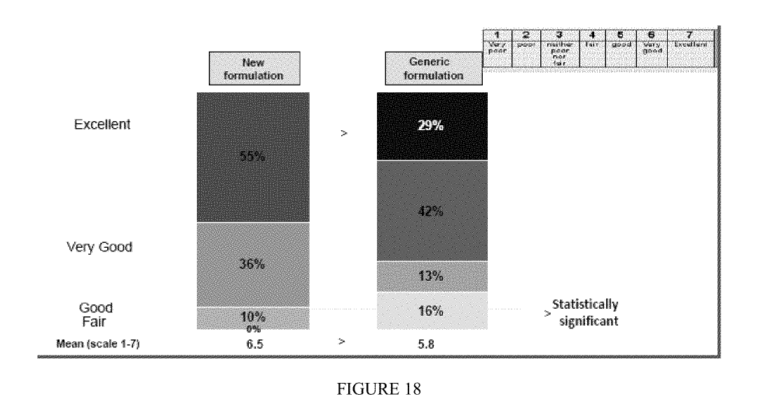

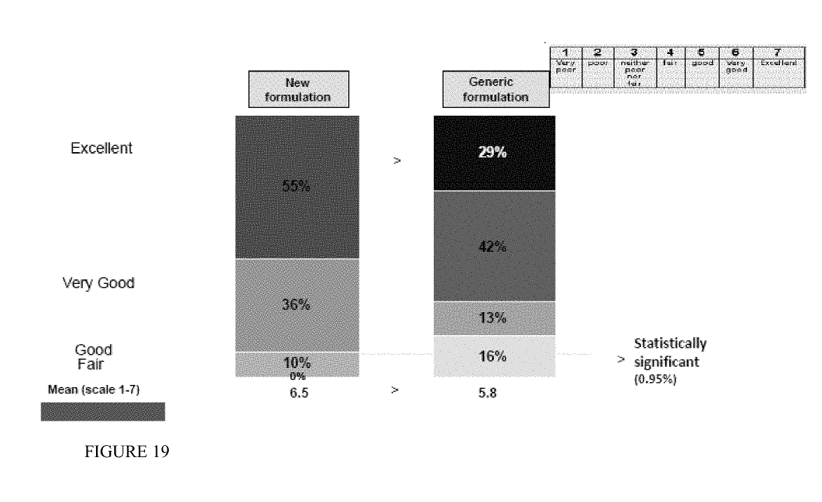

FIGS. 18 and 19 are graphs of the overall acceptance used in Example 3 for the sensory evaluation of soft serve made from pre-mix of the present invention compared to soft serve product made from reference pre-mix.

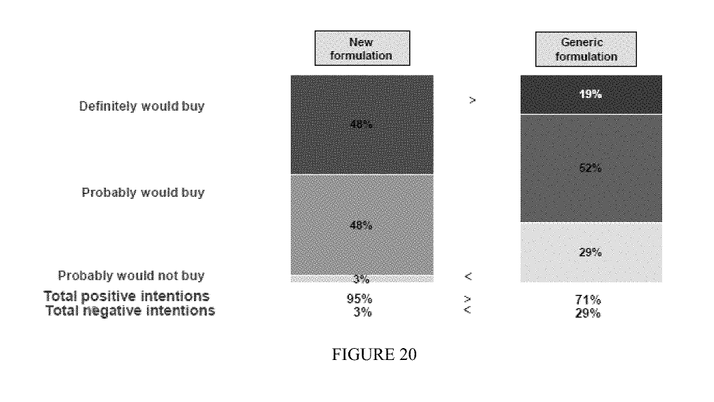

FIG. 20 is a graph of the purchase intent used in Example 3 for the sensory evaluation of soft serve made from pre-mix of the present invention compared to soft serve product made from reference pre-mix.

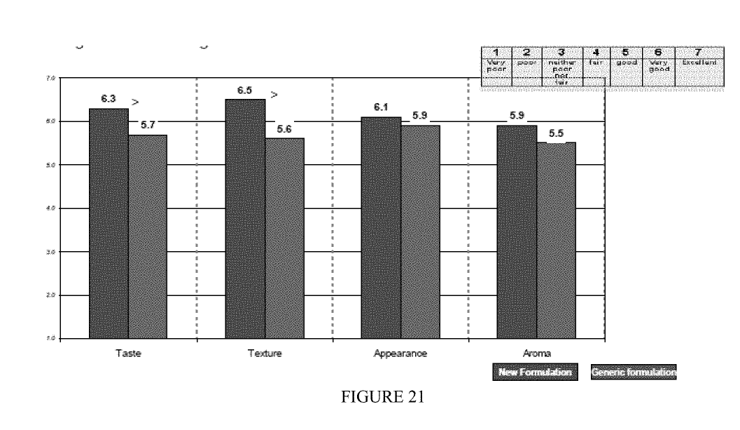

FIG. 21 is a graph of the average score used in Example 3 for the sensory evaluation of soft serve made from pre-mix of the present invention compared to soft serve product made from reference pre-mix.

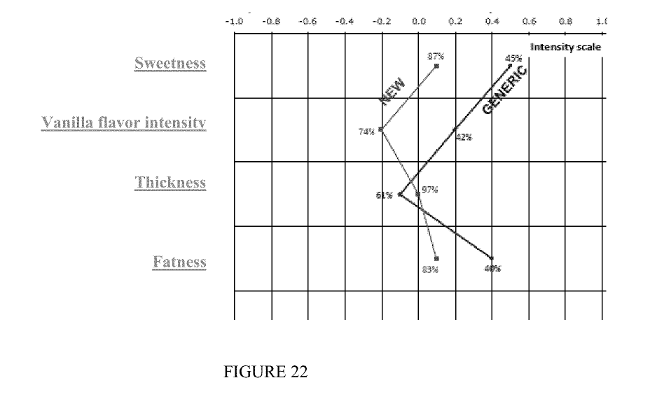

FIG. 22 is a graph of the sensory profile—average scores used in Example 3 for the sensory evaluation of soft serve made from pre-mix of the present invention compared to soft serve product made from reference pre-mix.

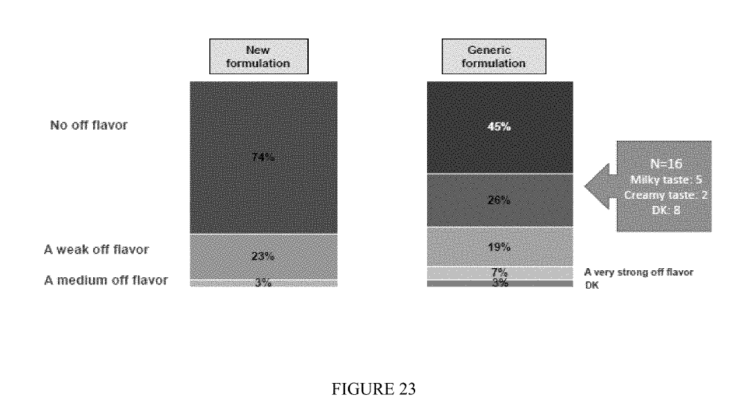

FIG. 23 is a graph of the off flavor used in Example 3 for the sensory evaluation of soft serve made from pre-mix of the present invention compared to soft serve product made from reference pre-mix.

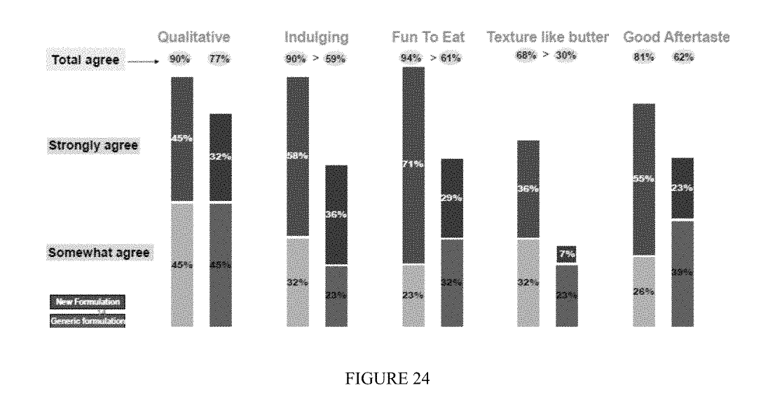

FIG. 24 is a graph of the perception aspects used in Example 3 for the sensory evaluation of soft serve made from pre-mix of the present invention compared to soft serve product made from reference pre-mix.

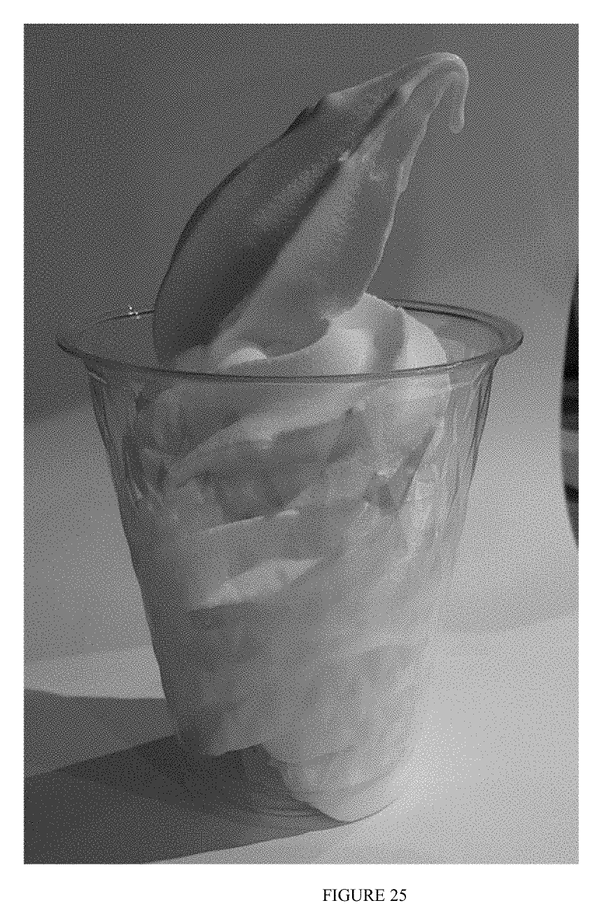

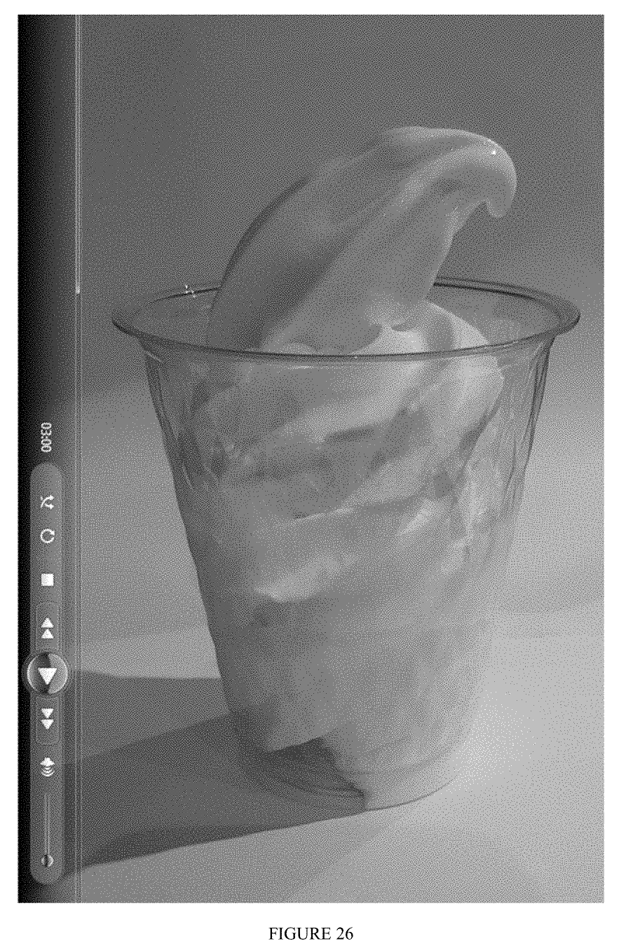

FIG. 25 is a photograph of the soft serve product made from reference pre-mix of Example 4 at time 0.

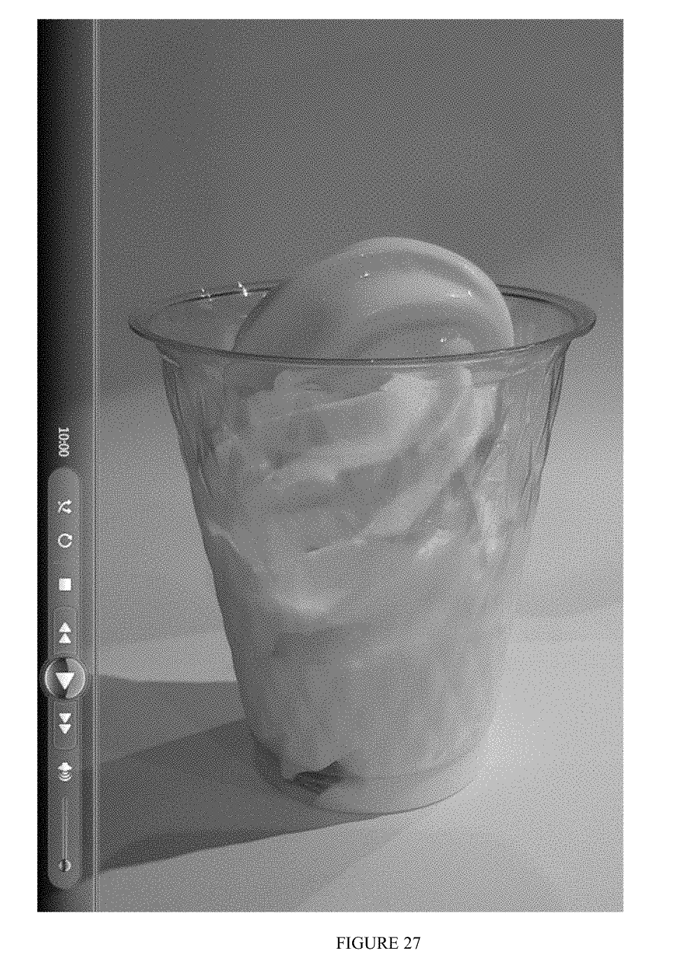

FIG. 26 is a photograph of the soft serve product made from reference pre-mix of Example 4 at 3 minutes.

FIG. 27 is a photograph of the soft serve product made from reference pre-mix of Example 4 at 10 minutes.

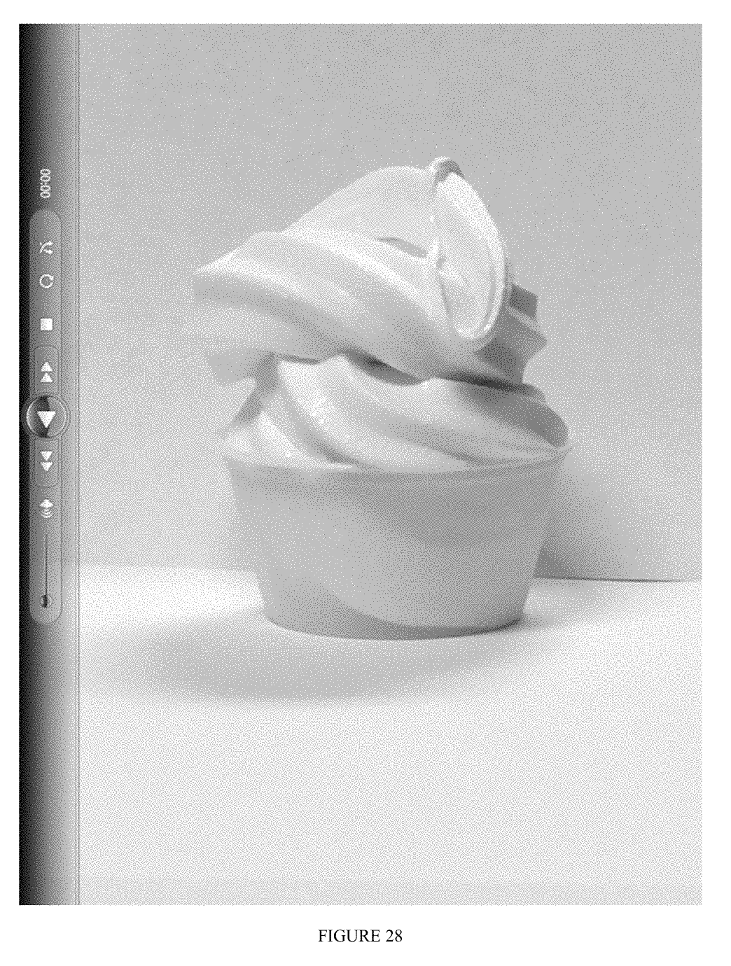

FIG. 28 is a photograph of the soft serve product made from pre-mix of the present invention of Example 4 at time 0.

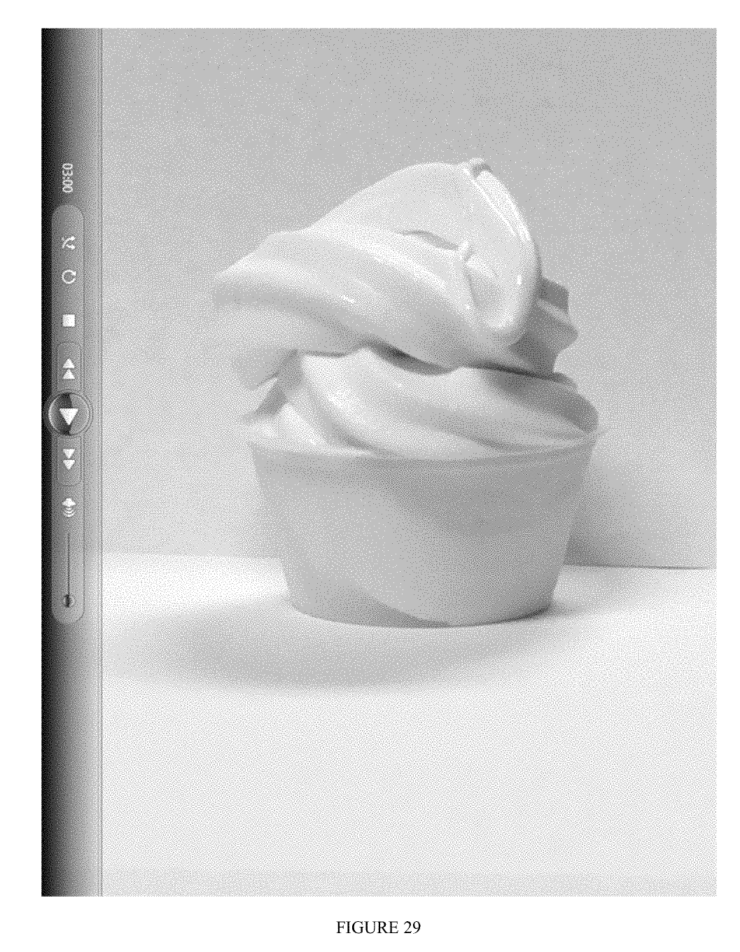

FIG. 29 is a photograph of the soft serve product made from pre-mix of the present invention of Example 4 at 3 minutes.

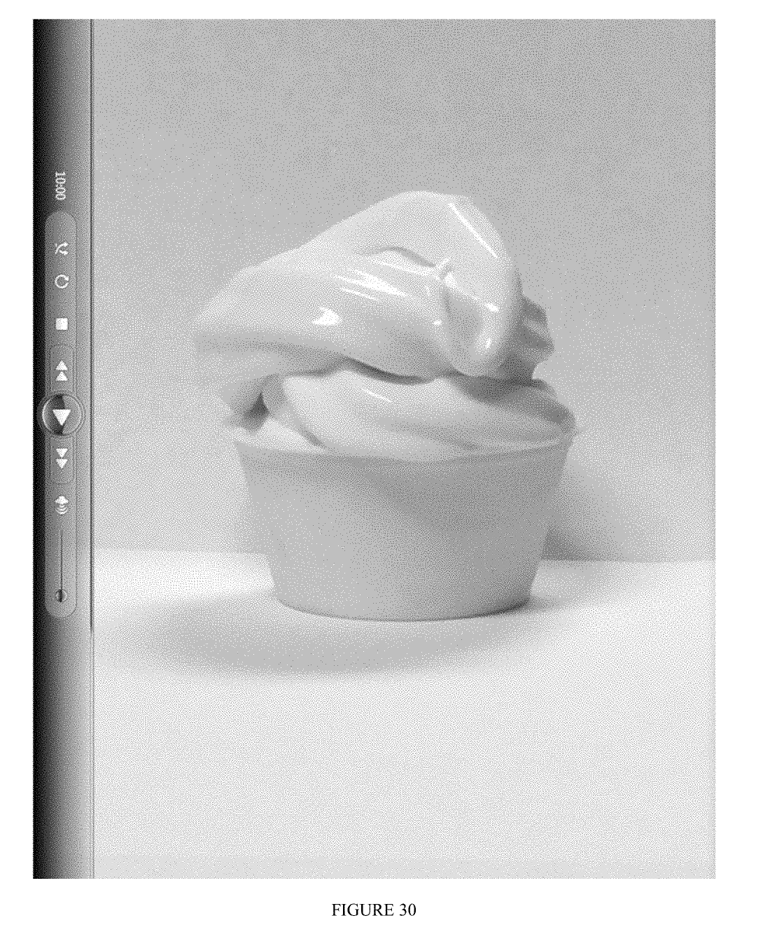

FIG. 30 is a photograph of the soft serve product made from pre-mix of the present invention of Example 4 at 10 minutes.

### DESCRIPTION OF EMBODIMENTS OF THE PRESENT INVENTION

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “organoleptic properties” includes the flavor display, texture, and sound of a food that are experienced by the eater of said food when said food is eaten.

As used herein, the term “single serving” means any quantity of food sold, marketed, described, advertised, or implied to be equivalent to a single serving size or unit. For example, in the U.S., single serving sizes for foods are defined in the FDA Labeling Rules as contained in 21 CFR § 101.12 which is incorporated herein by reference in its entirety.

As used herein, the term “fat” refers to the total amount of digestible, partially digestible and nondigestible fats or oils that are present in the embodiments of the present invention. As used herein, the terms “lipid”, “fat” and “oil” are synonymous.

As used herein, the term “carbohydrate” refers to the total amount of sugar alcohols, monosaccharides, disaccharides, oligosaccharides, digestible, partially digestible and non-digestible polysaccharides; and lignin or lignin like materials that are present in the embodiments of the present invention.

As used herein, a pre-mix is determined to “sweetness” based on the E-tongue test [see Example 1 for details].

As used herein, a pre-mix is determined to “bitterness” based on the E-tongue test [see Example 1 for details].

As used herein, a pre-mix is determined to “richness” based on the E-tongue test [see Example 1 for details].

As used herein, a pre-mix is determined to “after-taste” based on the E-tongue test [see Example 1 for details].

As used herein, the term “shelf life” is calculated based on the change in organoleptic properties of a food or drink in barrier packaging over time. In embodiments, the shelf-life will be determined based, at least in part, on lack of rancidity notes and texture (e.g., crunchiness) of the outer shell.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

In one embodiment, the present invention is a soft serve pre-mix formulation that provides improved nutritional values (i.e., reduced Sugar, reduced Fat, reduced Calories, reduced Cholesterol and enriched with Dietary Fibers when compared to a reference soft serve pre-mix composition having the following properties: i) nutritional data comprising: A) fat content: 4.5 grams/100 grams of composition; B) sugar content: 22 grams/100 grams of composition; ii) a formulation comprising: A) 73% milk (3% fat); B) 6% cream (38% fat); C) 4.5% skim milk powder; D) 13% sucrose; E) 3% glucose syrup (82%); F) less than 1% stabilizers and emulsifiers; and G) no added flavors.

In one embodiment, a sweetness index is defined as follows:

total sweetness index=sum(Ingredient's Sweetness Intensity Factor of each ingredient having a measured sweetness index multiplied by the Total % of Formulation)

In the following example, the calculation of formulations sweetness index is given in details in the following tables (Table 1 & 2, for present invention and reference pre-mix, respectively).

TABLE 1
Present Invention Pre-Mix Sweetness Index

| | Sweetness | | Ingredient's |
|---|---|---|---|
| | Intensity | % of | Sweetness |
| Ingredient | Factor | Formulation | Index |
| Sucralose | 600.00 | 0.004 | 2.4 |
| Maltitol | 1.00 | 9.1 | 9.1 |
| Maltitol Syrup | 0.75 | 3.6 | 2.7 |
| Glycerol | 0.80 | 1.4 | 1.1 |
| Maltodextrin | 0.06 | 3.6 | 0.2 |
| Lactose (from milk - 5%) | 0.16 | 76.5 * 0.05 | 0.6 |
| Lactose (from milk powder - | 0.16 | 3.6 * 0.5 | 0.3 |
| 49.8%) | | Formulation | 16.4 |
| | | Sweetness | |
| | | Index | |

TABLE 2
Reference Pre-Mix Sweetness Index

| | Sweetness | | Ingredient's |
|---|---|---|---|
| | Intensity | % of | Sweetness |
| Ingredient | Factor | Formulation | Index |
| Sucrose | 1.00 | 13.0 | 13.0 |
| Glucose Syrup | 1.00 | 3.0 | 3.0 |
| Lactose (from milk - 5%) | 0.16 | 72.5 * 0.05 | 0.6 |
| Lactose (from milk powder - | 0.16 | 4.8 * 0.5 | 0.4 |
| 49.8%) | | Formulation | 17.0 |
| | | Sweetness | |
| | | Index | |

The above calculations demonstrate the overlapping sweetness intensity of present invention pre-mix and the reference soft serve formulation (16.4 vs. 17.0, accordingly). Both formulations are within the range of sweetness intensity that was calculated for reference formulations (i.e., sweetness index: 13.9-19.6; Table 3).

TABLE 3
Conventional Soft serve ice cream composition

| | % of | ShakeUp | | Bulking |
|---|---|---|---|---|
| | Formulation | Case Study | Sweetness | agents |
| Ingredient | range* | Value [%]* | Index | content |
| Milk Fat | 3.0-6.0 | 5 | | |
| Sugar | 10.0-14.0 | 13 | 10.0-14.0 | 10-14 |
| Corn Syrup Solids | 3.0-4.5 | 3.1 | 3.0-4.5 | 3.0-4.5 |
| MSNF | 11.0-14.0 | 11 | 0.9-1.1 | 11.0-14.0 |
| Stabilizers + | 0.4-0.5 | 0.4 | | |
| Emulsifiers | | | | |
| Total Solids | 31.5-36.4 | 32.4 | | |
| | | | Total | Total |
| | | | Sweetness | Bulking |
| | | | Index | Agents** |
| | | | 13.9-19.6 | 13.0-18.5 |

1. *Data adopted from the book: Ice cream, 7^{th} et. by H. D Guff & R. W. Hartel 2013. Publisher: Springer Science.
2. **Excluding MSNF.

In one embodiment, the texture of the soft serve is affected mainly by the formulation bulking materials amount and type, and by fat content. Bulking agents that were added to the present invention pre-mix in order to provide typical soft serve ice cream texture are: polyols, dietary fibers (e.g., inulin), maltodextrin. In one example, the total content of bulking agents in present invention pre-mix and the reference are similar: 17.7% (maltitol, Maltitol syrup, glycerol, inulin & maltodextrin) for present invention pre-mix (Table 3).

In another embodiment, Fat replacers that were added to the formulation were pectin based. Pectin is a class of complex polysaccharides that function as a hydrating agent and cementing material for the cellulosic network. Commercial pectin is mostly derived from citrus and apple and is often standardized to obtain a uniform amount of pectin content. The ratio between the amounts of fat replacer in the current formulation to milk fat in the standard formulation should be within the following range:

$$\frac{Fat Replacer}{Replaced Milk Fat} = 0.1 - 0.2$$

With respect to texture of the final soft serve ice cream, process conditions (such as exposure to different temperatures over different times while heating or cooling, different over-run) may also contribute to the final texture of the soft-serve ice cream. However, the present invention pre-mix was prepared by typical process conditions with typical equipment, and in the same preparation method as the reference formulation. The final product—soft serve ice cream—of the present invention exhibited comparable texture of the final reference product. In addition, the present invention pre-mix was designed as a base formulation to allow for any flavor component to be added (e.g. chocolate, vanilla, strawberry). As such, since no added flavors were added during the testing of the soft serve pre-mix composition, there was no masking of the potential off-flavors of the base formulation.

TABLE 4
Example of Present Invention Formulation

| | | % of | |
|---|---|---|---|
| | | Formulation- | |
| | % of | Optional | |
| Ingredient | Formulation | Range | NFMS Content |
| Milk (1%) | 76.5 | 72.0-83.0 | 0.086 * 76.5 = 6.6 |
| Skim milk powder | 3.7 | 2.5-5.0 | 0.97 * 4.8 = 3.5 |
| Maltitol | 9.1 | 4.0-14.0 | — |
| Sucralose | 0.004 | 0.002-0.005 | — |
| Maltitol Syrup | 3.6 | 1.5-5.0 | — |
| Glycerol | 1.4 | 0.5-3.0 | — |
| Pectin based fat | 0.6 | 0.2-0.8 | — |
| replacer | | | |
| Inulin | 0.9 | 0.0-2.5 | — |
| Maltodextrin | 3.6 | 0.0-10.5 | — |
| Salt | 0.2 | 0.00-0.25 | — |
| Stabilizer & Emulsifier | 0.4 | 0.1-0.5 | — |
| | | | Total NFMS 10.1% |

TABLE 5
Examples of High intensity sweeteners sweetness characteristics

| | Sweetness |
|---|---|
| Ingredient | Intensity Factor |
| Aspartame | 200 |
| Acesulfame | 200 |
| potassium (Ace-k) | |
| Stevia | 250 |
| Saccharin | 300 |
| Sucralose | 600 |
| Neotame | 8,000 |
| Advantame | 20,000 |

In one embodiment, the pre-mix composition of the present invention that is made into a soft serve product of the present invention has substantially lower (e.g. 10%, 20%, 30%, 40%, or 50%) calories (i.e. energy) when compared to a reference pre-mix composition that is made into a soft serve product. At the same time, the consumer experience of the present invention is at least as good as the reference product (e.g. taste, appearance and mouthfeel).

In another embodiment, the pre-mix composition that is made into a soft serve product of the present invention has substantially lower (e.g. 50%, 60%, 70%, or 80%) fat content when compared to a reference pre-mix composition that is made into a soft serve product. At the same time, the consumer experience of the present invention is as good as the reference product (e.g. taste, appearance and mouthfeel).

In yet another embodiment, the pre-mix composition that is made into a soft serve product of the present invention has substantially lower (e.g. 40%-80%) sugar level when compared to a reference pre-mix composition that is made into a soft serve product. At the same time, the consumer experience of the present invention is as at least as good as the reference product (e.g. taste, appearance and mouthfeel).

In yet another embodiment, the pre-mix composition that is made into a soft serve product of the present invention has substantially lower (e.g. 10%, 20%, 30%, 40% or 50%) calories, fat content and/or sugar level and/or any combination therein when compared to a reference pre-mix composition that is made into a soft serve product. At the same time, the consumer experience of the present invention is at least as good as the reference product (e.g. taste, appearance and mouthfeel). In another embodiment, the consumer experience of the present invention is better than the reference product (e.g. taste, stability, mouthfeel and appearance).

In one embodiment, the invention provides a pre-mix composition that forms a soft serve product therein, the composition comprising 72.0% to about 83.0% of milk, 0.0% to about 5.0% of a 38-40% cream, 2.5% to 5.0% of a (0.5% fat) skim milk powder, 0.002% to 0.005% sucralose, 4.0% to 14.0% maltitol, 1.5% to 5.0% maltitol syrup, 0.5% to 3.0% glycerol, 0.00% to 0.25% salt, 0% to 10.5% maltodextrin and starches, 0.0% to 2.5% FOS (such as inulin), 0.1% to 0.5% stabilizers (combination of monoglycerides, diglycerides, locust bean gums, guar gums and carrageenan), 0.00% to 0.35% MCC and a mixture of at least pectin and citrus dietary fibers, each of said individual fibers being present in said mixture in an amount from 0.0% to 1.0% and the total amount of the mixture of fibers being from 0.0% to 3.5% by wt of the powdered composition.

In another embodiment, the invention provides a pre-mix composition that forms a soft serve product therein, the milk component comprises at least a portion skim milk. In another embodiment, the invention provides a pre-mix composition that forms a soft serve product therein, the milk component comprises a higher amount of cream [e.g. whole milk]. In another embodiment, the invention provides a pre-mix composition that forms a soft serve product therein, the milk component comprises at least a portion 1% milk. In another embodiment, the invention provides a pre-mix composition that forms a soft serve product therein, the milk component comprises at least a portion 3.7% milk. In yet another embodiment, some or all of the milk component is reconstituted milk [e.g. whole or skim].

In another embodiment, the fat used may be a dairy fat, a non-dairy fat, or a mixture of both. When the fat is a dairy fat, it may be for instance, any milk fat source such as butter oil, butter, real cream, or a mixture thereof. When the fat is a non-dairy fat it may be, for instance, an edible oil or fat, preferably a vegetable oil such as coconut oil, palm kernel oil, palm oil, cotton oil, peanut oil, olive oil, soy bean oil, etc., or mixtures thereof.

Suitable emulsifiers include but, are not limited to, propylene glycol monostearate (“PGMS”), sorbitan tristearate (“STS”), lactylated monoglycerides, acetylated monoglycerides, unsaturated monoglycerides, including monoglycerides with oleic acid, linoleic acid, linolenic acid, or other commonly available higher unsaturated fatty acids. In one example, the emulsifier blend should be present in an amount of 0.1% to 0.6%, in another embodiment, an amount of 0.2% to 0.5%, in another embodiment, an amount of 0.2% to 0.3%.

Suitable stabilizers include, but are not limited to, a hydrocolloid such as agar, gelatin, gum acacia, guar gum, locust bean gum, gum tragacanth, carrageenan and its salts, carboxymethyl cellulose, sodium alginate or propylene glycol alginate, or any mixture of hydrocolloids.

FIGS. 1, 2 and 3 illustrate one embodiment for the process for the preparation of the pre-mix of the present invention.

In another embodiment, the process for the soft serve product made from the pre-mix composition of the present invention can be carried out using conventional equipment. The first step generally comprises mixing the ingredients under shear mixing to disperse and/or solubilize the ingredients into a homogeneous mass. Thereafter, the homogeneous mass is preheated, e.g., to a temperature of about 50° C. to about 75° C. The preheated homogeneous mass is conventionally homogenized, e.g., in a two stage homogenizer. The first stage is conducted at a pressure of about 70 bar to about 250 bar. The second stage is conducted at a pressure of about 0 bar to about 50 bar. Pasteurization of the homogenized mass is conducted under conditions commonly used in the industry.

The pasteurization step is conducted at a temperature of about 50° C. to about 100° C. for a time of about 10 seconds to about 30 minutes. Pasteurization may be conducted by either high temperature short time (HTST) or low temperature long time (LTLT) processing.

After pasteurization, the mix is aged by allowing to stand at a temperature of about 0° C. to about 8° C. for a time of about 4 hour to about 24 hours.

The mix is then colored and flavored as needed.

Subsequently, the mix is allowed to aerate in a conventional freezer for bulk, extruded, or cone products. If the mix is whipped using a conventional freezer, any freezer commonly used in the industry can be used to whip the mixture, e.g. Hoyer, CBW, PMS, etc. The mix is normally pumped into the freezer at a temperature of about −2° C. to about −8° C. and substantially simultaneously an appropriate amount of air is introduced into the mix. The step of freezing under agitation is conducted depending upon the freezing point of the mix. The time required is dependent on the amount of mix and air, and the pumping flow rate.

Biological (natural) and/or synthetic flavors and colors can be used in the pre-mix compositions. These include, for example: chocolate, mocca, yoghurt, various cultured milk powders, also: vanilla, nuts, fruits, aromatic flowers and aromatic parts of plants such as cinnamon. Also combinations thereof such as for example: vanilla and chocolate or fruit and nuts or two or more fruits or yoghurt and fruits or leben and flower or yoghurt and cinnamon, etc.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of the principles and conceptual aspects of the invention.

The following nutritional analysis is conducted by the following tests (unless specified otherwise): dietary fiber AOAC 991.43; sugar: Nestle LI 00.544-3; and fat: Nestle LI00.527-1.

In one embodiment, the soft serve pre-mix composition of the present invention comprises: a) nutritional data comprising: i) calories: 80-125 kcal/100 grams of composition; ii) protein content: at least 3 grams/100 grams of composition; iii) fat content: 0.5-3 grams/100 grams of composition; iv) sugar content (as lactose, originated from the milk): 4-7 grams/100 grams of composition; and v) dietary fiber content: 0.5-5 grams/100 grams of composition; b) a formulation comprising: i) a total sweetness index of between 13 to 20, wherein the sweetness index is calculated by:

total sweetness index=sum(Ingredient's Sweetness Intensity Factor of each ingredient having a measured sweetness index multiplied by the Total % of Formulation);

ii) 13-19% of bulking agents (wet weight basis of total composition); wherein the bulking agent is selected from the group of bulking agents consisting of polyols, glycerols, dietary fiber, maltodextrin and combinations thereof; iii) 0.2-0.8% of pectin (wet weight of total composition); iv) 8-13% of non-fat milk solids (“NFMS”) (wet weight of total composition); c) wherein the taste profile of the soft serve pre-mix composition has an overlapping taste profile when compared to a soft serve pre-mix composition having the following properties: i) nutritional data comprising: A) fat content: 4.5 grams/100 grams of composition; B) sugar content: 22 grams/100 grams of composition;

ii) a formulation comprising: A) 73% milk (3% fat); B) 6% cream (38% fat); C) 4.5% skim milk powder; D) 13% sucrose; E) 3% glucose syrup (82%); F) less than 1% stabilizers and emulsifiers; and G) no added flavors.

In one embodiment, the soft serve pre-mix composition of the present invention comprises: a) nutritional data comprising: i) calories: 80-110 kcal/100 grams of composition; ii) protein content: at least 3 grams/100 grams of composition; iii) fat content: 0.5-2 grams/100 grams of composition; iv) sugar content: 4-7 grams/100 grams of composition; and v) dietary fiber content: 1-2 grams/100 grams of composition; b) a formulation comprising: i) a total sweetness index of between 13 to 19, wherein the sweetness index is calculated by:

total sweetness index=sum(Ingredient's Sweetness Intensity Factor of each ingredient having a measured sweetness index multiplied by the Total % of Formulation);

ii) 13-19% of bulking agents (wet weight basis of total composition); wherein the bulking agent is selected from the group of bulking agents consisting of polyols, glycerols, dietary fiber, maltodextrin and combinations thereof; iii) 0.4-0.8% of pectin (wet weight of total composition); iv) 8-13% of non-fat milk solids (“NFMS”) (wet weight of total composition); c) wherein the taste profile of the soft serve pre-mix composition has an overlapping taste profile when compared to a soft serve pre-mix composition having the following properties: i) nutritional data comprising: A) fat content: 4.5 grams/100 grams of composition; B) sugar content: 22 grams/100 grams of composition;

ii) a formulation comprising: A) 73% milk (3% fat); B) 6% cream (38% fat); C) 4.5% skim milk powder; D) 13% sucrose; E) 3% glucose syrup (82%); F) less than 1% stabilizers and emulsifiers; and G) no added flavors.

In one embodiment, the soft serve pre-mix composition of the present invention comprises: a) nutritional data comprising: i) calories: 65-140 kcal/100 grams of composition; ii) protein content: at least 3 grams/100 grams of composition; iii) fat content: 0.5-5 grams/100 grams of composition; iv) sugar content: 4-15 grams/100 grams of composition; and v) dietary fiber content: 0.5-8 grams/100 grams of composition; b) a formulation comprising: i) a total sweetness index of between 11 to 22, wherein the sweetness index is calculated by:

total sweetness index=sum(Ingredient's Sweetness Intensity Factor of each ingredient having a measured sweetness index multiples by the Total % of Formulation);

ii) 10-20% of bulking agents (wet weight basis of total composition); wherein the bulking agent is selected from the group of bulking agents consisting of polyols, glycerols, dietary fiber, maltodextrin and combinations thereof; iii) 0-1.5% of pectin (wet weight of total composition); iv) 7-20% of non-fat milk solids (“NFMS”) (net weight of total composition); c) wherein the taste profile of the soft serve pre-mix composition has an overlapping taste profile when compared to a soft serve pre-mix composition having the following properties: i) nutritional data comprising: A) fat content: 4.5 grams/100 grams of composition; B) sugar content: 22 grams/100 grams of composition;

ii) a formulation comprising: A) 73% milk (3% fat); B) 6% cream (38% fat); C) 4.5% skim milk powder; D) 13% sucrose; E) 3% glucose syrup (82%); F) less than 1% stabilizers and emulsifiers; and G) no added flavors.

In one embodiment, the Pre-mix of the present invention comprises:

A) Energy: 80-125 kcal/100 grams of pre-mix;

B) Protein: 3-20 g/100 grams of pre-mix;

C) Fat: 0-6 g/100 grams of pre-mix;

D) Carbohydrates: 10-40 g/100 grams of pre-mix;

E) Sugar 4-10 g/100 grams of pre-mix;

F) Dietary fiber: 0-10 g/100 grams of pre-mix;

In another embodiment, the pre-mix composition of the present invention comprises:

A) Energy: 80-110 kcal/100 grams of pre-mix;

B) Protein: 3-8 g/100 grams of pre-mix;

C) Fat: 0.5-2.5 g/100 grams of pre-mix;

D) Carbohydrates: 10-40 g/100 grams of pre-mix;

E) Sugar: 4.5-6.5 g/100 grams of pre-mix;

F) Dietary fiber 0.5-4.5 g/100 grams of pre-mix;

In another embodiment, the Pre-Mix of the present invention comprises:

A) Energy: 80-125 kcal/100 grams of pre-mix;

B) Protein: 3-8 g/100 grams of pre-mix;

C) Fat: 0.5-4.0 g/100 grams of pre-mix;

D) Carbohydrates: 10-40 g/100 grams of pre-mix;

E) Sugar: 4.5-12 g/100 grams of pre-mix;

F) Dietary fiber 0-4.0 g/100 grams of pre-mix;

In yet another embodiment, the soft serve product of the present invention, made from the pre-mix of the present invention comprises:

A) Energy: 93 kcal/100 grams of pre-mix;

B) Protein 4.0 g/100 grams of pre-mix;

C) Fat 1.0 g/100 grams of pre-mix;

D) Carbohydrates 24 g/100 grams of pre-mix;

E) Sugar milk originated lactose 5.6 g/100 grams of pre-mix;

F) Dietary fiber 1.8 g/100 grams of pre-mix;

In contrast, the nutritional analysis of the reference Pre-Mix is typically:

Calories: 130-180 kcal/100 grams of pre-mix
Protein: 2.0-5.0 g/100 grams of pre-mix
Fat: 4.5-10.0 g/100 grams of pre-mix
Carbohydrates: 20-30 g/100 grams of pre-mix
Sugar 14-20 g/100 grams of pre-mix
Dietary fiber: 0 g/100 grams of pre-mix

In another embodiment, the pre-mix composition of the present invention comprises:
Sweetening agents: sucralose, polyols (e.g., xylitol, lactitol, maltitol), stevia 10-30 g/100 grams of pre-mix;
Dairy based proteins sources: whey protein, protein extract, milk powder (whole to skim milk), milk (whole to skim)
10-90 g/100 grams of pre-mix;
Texturizing agents: milk fat, cream, mono-glycerides, di-glycerides, guar gum, xanthan gum, locust bean gum, gellan gum, carrageenan, starch, dextrose, dietary fibers (citrus, pectin, inulin). Former ingredients could be modified or natural.

In another embodiment, the pre-mix composition of the present invention comprises:
Sweetening agents: sucralose, polyols (e.g., xylitol, lactitol, maltitol), stevia 15-30 g/100 grams of pre-mix;
Dairy based proteins sources: whey protein, protein extract, milk powder (whole to skim milk), milk (whole to skim)
70-90 g/100 grams of pre-mix;
Texturizing agents: milk fat, cream, mono-glycerides, di-glycerides, guar gum, xanthan gum, locust bean gum, gellan gum, carrageenan, starch, dextrose, dietary fibers (citrus, pectin, inulin). Former ingredients could be modified or natural.

In another embodiment, the pre-mix composition of the present invention comprises sweetening agents comprising sucralose, polyols (e.g., xylitol, lactitol, maltitol), and stevia. In yet another embodiment, the maltitol/sucralose ratio is 99.5/0.5%. In yet another embodiment, the maltitol/sucralose ratio is 99.9%/0.1%. In yet another embodiment, the maltitol/sucralose ratio is between 99.0-99.9% maltitol to 0.1-1.0% sucralose. In yet another embodiment, the combination is polyol and sucralose. In yet another embodiment, the combination is polyol and stevia. In yet another embodiment, the polyol/stevia ratio is 98.0%-2%. In yet another embodiment, the polyol/stevia ratio is 99.8%-0.2%. In yet another embodiment, the polyol/stevia ratio is between 98.0-99.8% polyol to 2.0-0.2% stevia. In yet another embodiment, the polyol/sucralose ratio is 99.0%-1%. In yet another embodiment, the polyol/sucralose ratio is 99.9%-0.1%. In yet another embodiment, the polyol/sucralose ratio is between 99.0-99.9% polyol to 1.0-0.1% sucralose.

In one embodiment, the pre-mix of the present invention comprises the following formulation as shown in Table 6:

TABLE 6

| Ingredient | Functionality | Qn + |
|---|---|---|
| milk 1.0% | Basic ingredient | 72-83 |
| cream 38% | Fat + flavor | 0-5 |
| Skim milk powder | Basic ingredient | 2.5-5.0 |
| (0.5% fat) | | |
| Sucrelose | Sugar substitute | 0.002-0.0045 |
| Maltitol | sweetener | 4.0-14.0 |
| Maltitol syrup | Sugar substitute + | 1.5-5.0 |
| | Texture + taste | |
| Glycerol | Lowering melting point | 0.5-3.0 |
| Salt (Na—Cl) | Lowering melting point | 0.00-0.25 |
| Maltodextrin & starches | Texture | 0.0-10.5 |
| Inulin | Thickener + Pre biotic | 0.0-2.5 |
| | dietary fiber | |
| Pectin & citrus based | Fat replacer + Thickener + | 0.0-1.0 |
| dietary fibers | dietary fiber | |
| Stabilizer (combination of: | Stabilizer | 0.1-0.5 |
| monoglycerides, | | |
| diglycerides, Locust Bean | | |
| Gum, Guar Gum, | | |
| Carrageenan) | | |
| MCC | Anti-crystallization agent | 0.00-0.35 |

In another embodiment, the soft serve product of the present invention made from the pre-mix of the present invention has the following properties:

### Storage: Store at 2-8° C.

Shelf life: at least 21 days at 2-8° C.

In one example, the reference pre-mix composition of Table 7 comprises:

TABLE 7
(g/100 grams of pre-mix)

| | | |
|---|---|---|
| Milkfat | 5.0 | |
| MSNF | 1.0 | (skim milk solids) |
| Sucrose | 13.0 | |
| CSS 36 DE | 3.0 | (glucose syrup solids) |
| Stabilizer | 0.1 | |
| Emulsifier | 0.1 | |
| Total Solids | 32.2 | |
| Calories | 150 | kcal/100 grams of pre-mix |

The following examples and accompanying drawings further illustrate embodiments of the present invention but are not meant to limit the present invention. As illustrated in the Examples 1, 2, 3 and 4, the soft serve product made from the pre-mix composition of the present invention [“new formulation” ] is equivalent in taste to the soft serve product made from reference pre-mix [“reference formulation” ].

### Example 1: Taste Profile of Pre-Mix of the Present Invention Compared to Pre-Mix Made from Reference Pre-Mix

The following example demonstrates that the taste profile of the pre-mix composition of the present invention is comparable to the reference pre-mix composition.

Formula for Pre-Mix of Present Invention (“Sample 2”—“New Formulation”) is shown in Table 8.

TABLE 8

| Ingredient | Amount (%) |
|---|---|
| milk 1% | 76.5 |
| skim milk powder | 3.6 |
| Sucralose | 0.004 |
| maltitol Syrup | 3.6 |
| Glycerol | 1.4 |
| Stabilizer | 0.3 |
| Maltitol | 9.1 |
| Pectin (fat replacer) | 0.6 |
| Inulin | 0.9 |
| Salt | 0.2 |
| MCC | 0.1 |
| MD 1 | 3.6 |

Formula for Pre-Mix of Reference Soft Serve Product (“Sample 1”-“Reference Formulation”) is shown in Table 9.

TABLE 9

| Ingredient | Amount (%) |
|---|---|
| milk 3.0% | 72.5 |
| cream 38% | 6.3 |
| skim milk powder | 4.8 |
| Sugar | 13.0 |
| glucose 82% | 3.1 |
| Sstabilizer | 0.2 |

Both formulations were prepared as follows:

Pre-weighted powders were added to pre-heated warm milk (30° C.) inside the pasteurizer (Cattabriga, Model Mix 7, Italy). The mixture was continuously stirred and heated. Fluids were added to the mixture at 50° C. The mixture was heated to 74° C., then cooled to about 40° C. and placed in the refrigerator (2-8° C.) for at least 8 h. The mixture was then passed through homogenizer (SPX, Model APV-2000). Two homogenization steps were carried out by passing the mix through two valves at 40° C. The homogenous conditions per each formulation were adjusted to the fat content; Sample 1 formulation was homogenized at 220 bar/50 bar, while Sample 2 was homogenized at 270 bar/30 bar.

The following test method is collectively referred to as the “E-tongue test.” The experiment was done at the food Sensory Laboratory at Tel Hai College. The E-tongue model was SA402B from INSENT Company in Japan. The device is designed to characterize the taste profile of food products and medicines based on the selective attraction of different taste molecules. The device contains a number of sensors that consist of a unique lipid membrane that can bind to taste molecules according to electrical and hydrophobic attractions. The electronic tongue can measure the following taste attributes: sweetness, bitterness, and richness. In addition, the instrument allows to measure aftertaste after a brief rinse with water and then repeat the measurement reading to indicate of any remain taste molecules attached to the membrane. The advantages of the electronic tongue is the ability to receive taste detection in respect to human perception, the ability to distinguish between products objectively, low sensory threshold for identifying low concentrations of tastes and the possibility of an evaluating of the impact of interactions between molecules.

### Sensors in use:

1. COO—sensor for negative bitter compound, like iso-alpha acids that exist in beer, coffee.
AAE—sensor for richness, sensitive to glutamic acid and similar molecules.
GL1—sensor for sweetness, detect natural sugars.

CPA values—signal from sensor AEE, and C00 after short rinse with reference solution. This signal mimics the aftertaste from richness, and bitterness.

Table 10 shows the standard values for working sensors.

### Operation Method Using the Sensors:

A food set of 5 sensors plus sweetness sensors, all brand new were used in the project. The sensors were cleaned between samples and checked to reach stability of 0.5±mV before the actual reading. 4 repetitions were done to each sample. The results were analyzed using Excel 2007 and XLstat statistical software.

Reference solution (0.3 mM tartaric acid and 30 mM KCl)—used to clean the sensors between the measurements and to stable the reading before sample reading.

Cleaning solutions—acidic and alkaline solutions with high concentration of HCl and NaOH are used to clean the sensors after sample reading.

Operation steps using the electronic-tongue (from:
1. Aftertaste measurement (30 s)
2. Rapid rinse (3 s)
3. Rapid rinse (3 s)
4. Sample reading (30 s)
5. Stability check for the sensors
6. Washing the sensors at reference solution for 90 s
7. Washing the sensors at reference solution for 90 s
8. Rinsing the sensors for 120 s in cleaning solutions
Samples: a) Pre-Mix of the present invention

b) reference Pre-Mix

Five repetitions from each recipe were prepared separately.
Preparation method: Samples were diluted 1:1 with distilled water to reduce the thick viscosity.

Table 11 is a table illustrating the parameters of a sensor check.

Sensors were in working condition to perform the run according to the validation range.

Table 12 is a table illustrating the parameters of a taste solution check.

The sensors were checked with specified taste solutions that were prepared before the trial to see the selectivity and the condition of the sensors. The mentioned range values are according to manufacture. The results derived from the dominant sensors that reacted to the taste solutions. The other sensors exhibited very low or even no reading at all.

### Results:

Table 13 presents the raw data from the sensors according to the 2 set of dairy recipes of the present invention. The main difference between the samples can be seen for sensor CT0 and AE1. The CT0 higher values for sample #2 are correlated with higher conductivity result seen at Table 14.

TABLE 13
Raw data from the E-Tongue sensors including CPA values

| | AAE | CT0 | CA0 | C00 | AE1 | cpa (AAE) | cpa (C00) | cpa (AE1) | GL1 |
|---|---|---|---|---|---|---|---|---|---|
| 1.1 | −23.19 | 6.65 | −34.36 | −75.93 | −7.75 | −11.54 | 2.78 | −2.01 | −79.51 |
| 1.2 | −23.23 | 6.73 | −34.36 | −75.72 | −7.79 | −11.37 | 2.42 | −1.91 | −79.61 |
| 1.3 | −23.47 | 6.83 | −34.54 | −75.56 | −7.35 | −10.97 | 1.93 | −1.72 | −79.80 |
| 1.4 | −23.16 | 6.71 | −34.37 | −75.83 | −7.54 | −10.71 | 1.75 | −1.84 | −79.67 |
| 1.5 | −23.22 | 6.57 | −34.52 | −75.58 | −7.28 | −10.55 | 2.48 | −1.77 | −79.74 |
| 2.1 | −19.50 | −5.94 | −29.98 | −73.03 | −18.67 | −13.01 | 3.65 | −1.97 | −71.85 |
| 2.2 | −19.27 | −6.00 | −30.18 | −72.9 | −19.08 | −13.87 | 2.21 | −2.21 | −71.65 |
| 2.3 | −19.48 | −6.81 | −30.31 | −74.03 | −20.02 | −15.13 | 1.82 | −2.44 | −71.54 |
| 2.4 | −19.50 | −6.85 | −30.42 | −73.42 | −20.15 | −14.77 | 0.96 | −2.44 | −71.94 |
| 2.5 | −19.57 | −6.52 | −30.84 | −73.44 | −19.50 | −15.52 | 0.16 | −2.44 | −71.55 |

TABLE 14
pH and conductivity output

| | | conductivity |
|---|---|---|
| sample | pH | (mS/cm) |
| 1.1 | 6.70 | 2.51 |
| 1.2 | 6.70 | 2.49 |
| 1.3 | 6.68 | 2.48 |
| 1.4 | 6.73 | 2.48 |
| 1.5 | 6.72 | 2.48 |
| 2.1 | 6.60 | 3.41 |
| 2.2 | 6.60 | 3.38 |
| 2.3 | 6.59 | 3.40 |
| 2.4 | 6.59 | 3.38 |
| 2.5 | 6.59 | 3.36 |

FIG. 5: Comparison between two recipes of the present invention (5 repetitions each recipe). In FIG. 5 the results from all the samples are given in spider web according to sensor output.

FIG. 6: Spider web for human converted taste profile of the two samples. FIG. 6 describes the same output in a spider web plot, but here the values were converted to human sensory intensity scale according to manufacture algorithm. Difference in more than 1 unit points out a significant different in taste perception, which accounts for more than 20% difference in the sample taste molecules related to the sensor.

The results from FIG. 6 show very similar pattern to both samples with slight difference for richness (derived from AAE CPA result). The converted values are based on real sensory panel and the algorithm takes into account difference in taste intensity for increased concentrations. FIG. 7 show the results as average between all the 5 repetitions.

FIG. 8: Average output from the two samples.

FIG. 9: Comparison between the two samples after sensor conversion.

Despite the fact that the samples show similar values, still differences can be seen in FIG. 9 when sample #2 is compared to sample #1. The sensors that show the most significant difference is slightly with bitterness and sweetness sensors.

### Conclusions:

A. The taste profile of two samples were analyzed using the E-Tongue and the results are presented in table 1-2 and FIGS. 5-9.

B. The taste profile for the two samples is equivalent because there were no significant differences for the major taste attributes in the dairy samples: sweetness, and bitterness.

C. The E-Tongue is highly sensitive and capable to distinguish between the samples (70.71% in X axis) despite the general conclusion of high similarity. The E-Tongue with all the 6 sensors showed that there is a clear separation between the samples. The bitterness and richness and aftertaste sensors were the most reactive for the difference between the samples. It is common that other charged molecules exist in the sample may affect the sensor output but without real effect on the taste.

### Example 2: Physical Characterization of Pre-Mix of the Present Invention Compared to Reference Pre-Mix

### Protocols:

Samples were prepared and received a day before and kept at 4° C. over-night before analyses. The same formulas, as detailed in Example 1, were used in Example 2. Sample 1 was the reference pre-mix. Sample 2 was pre-mix formulation of the present invention. The tests were conducted at Technion University, Israel.

Droplet size: mean droplets size and particle distribution (PSD) curves were measured using a Mastersizer 3000 (Malvern Instruments, UK), at room temperature. Each sample was measured twice; each measurement comprised of five repeated determinations of static laser scattering and processed assuming dispersed phase has optical properties like common edible oil.

Viscosity: viscosity of the samples was measured in duplicates using a temperature controlled viscometer (Brookfield Engineering Labs).

Stability: Each sample was measured in duplicates using analytical centrifugation preformed on a LUMisizer (LUM GmbH). This was done under two separate conditions: first under 2000 RPM for 8 hours and then after 24 hours under 4000 RPM for 25 hours. All measurements were done at 4° C.

### Results:

### Droplet Size:

All Averaged PSDs were calculated and are presented in FIG. 10—averaged droplet size distribution curves of samples #1 (green) and #2 (red) (n=10). As can be seen in FIG. 10, in sample #1, the droplet population was uniform and mono-modal with a fine mean volume weighed diameter (D(4,3)=0.4767, STDV=0.06) while sample #2 was found to comprise of two separate droplet populations, one being of sub-micron droplets and one of bigger droplets of ˜100 [symbol] m.

FIG. 11 displays the shear stress and viscosity of the two samples against elevated shear rate. These findings support a significant difference in viscosity of the samples and their shear thinning behavior, with sample #2 exhibiting higher viscosity. Accelerated stability measurements also demonstrated the differences between samples 1 and 2. Sample 1, representing the soft serve product made from the reference pre-mix—exhibited a Newtonian pattern—while sample 2, the soft serve product made from pre-mix formulation of the present invention exhibited a typical Pseudo-plastic behavior.

FIG. 12 shows direct images the cuvettes from the Lumisizer after analyses of 8 hours under 2000 RPM. Yellow arrows mark the separation between the phases. As demonstrated from FIG. 12, under these centrifugation conditions, samples were just partly separated and no quantitative stability analysis could be made. Samples were then run again at 4000 RPM for 25 hours and the resulting cuvettes and analysis are presented in FIGS. 13 & 14.

As can be seen in FIG. 13, under these conditions, samples were completely separated, therefore, calculation of averaged instability indexes was feasible and is presented in FIG. 14. This figure shows significant differences (p<0.01) between samples with sample 1 having a higher instability index than Sample 2, which indicates sample 1 is less stable to physical separation than sample 2.

FIGS. 15A and B were the space and time resolved extinction profiles recorded during analytical centrifugation of the samples. These images were used to calculate the instability indices of the samples.

### Example 3: Sensory Evaluation of Soft Serve Product Made from Pre-Mix of the Present Invention Compared to Soft Serve Product Made from Reference Pre-Mix

Samples were prepared and received a day before and kept at 4° C. over-night before analyses. The same formulas, as detailed in Example 1, were used in Example 3. The products were prepared in a reference soft serve ice cream machine and were served in a transparent plastic cup to the panel. Each panelist tasted both products. The soft serve sample made from the pre-mix of the present invention (“New Formulation”) was always served first. The product were coded with a 3 digits code, and tasted in a “blind-test”—the brands were not revealed. The products were tested in a Sequential Monadic test design and a full sensory profile analysis was performed. The target audience was 31 youths: 74% aged 12-18 and 26% adults 18+(52% male 48% female) evaluated each product. All were consumers of ice-cream and non rejecters of vanilla flavor products.

The results are: 68% of the test consumers stated that the texture of the new formulation is “like butter” and only 30% stated that the texture of the reference formulation is “like butter”; 81% of the test consumers stated that the new formulation has a good aftertaste and only 62% stated that the reference formulation has a good aftertaste; 94% of the test consumers stated that it is fun to eat the new formulation and only 61%% stated that the reference formulation is fun to eat; and 90% of the test consumers stated that the new formulation is indulging to eat and only 59%% stated that the reference formulation is indulging to eat.

FIG. 16 is the hedonic scale used in Example 3 for the sensory evaluation of soft serve product made from pre-mix of the present invention compared to pre-mix made from reference pre-mix (“Reference Formulation”).

FIG. 17 is the intensity scale used in Example 3 for the sensory evaluation of soft serve product made from pre-mix of the present invention compared to pre-mix made from reference pre-mix.

FIGS. 18 and 19 are graphs of the overall acceptance used in Example 3 for the sensory evaluation of soft serve product made from pre-mix of the present invention compared to the soft serve product made from reference pre-mix. The soft serve product made from the pre-mix of the present invention showed a very high overall acceptance—slightly more than half of the participants gave the maximum score of 7. In contrast, the overall acceptance of the soft serve product made from the reference pre-mix was lower compared to the soft serve product made from pre-mix of the present invention.

FIG. 20 is a graph of the purchase intent used in Example 3 for the sensory evaluation of soft serve product made from pre-mix of the present invention compared to the soft serve product made from reference pre-mix. The purchase intent for the soft serve product made from pre-mix of the present invention was higher than soft serve product made from pre-mix of the present invention.

FIG. 21 is a graph of the average score used in Example 3 for the sensory evaluation of soft serve product made from pre-mix of the present invention compared to pre-mix made from reference pre-mix. The taste and texture scores of the soft serve product made from pre-mix of the present invention were very high compared to the soft serve product made from the reference pre-mix.

FIG. 22 is a graph of the sensory profile—average scores used in Example 3 for the sensory evaluation of soft serve made from pre-mix of the present invention compared to soft serve product made from reference pre-mix. Comparing the sensory profile of both products, the compatibility of sweetness perception in the soft serve product made from pre-mix of the present invention was higher compared to the soft serve product made from the reference pre-mix. Regarding fatness, the soft serve product made from the pre-mix of the present invention is closer to optimum (83% were satisfied with the soft serve product made from pre-mix of the present invention compared to 40% for the soft serve product made from reference pre-mix. The satisfaction from the vanilla flavor intensity and the thickness was higher for the soft serve product made from pre-mix of the present invention.

FIG. 23 is a graph of the off flavor used in Example 3 for the sensory evaluation of soft serve product made from pre-mix of the present invention compared to soft serve product made from reference pre-mix. There was no off-flavor detected for the soft serve product made from pre-mix of the present invention.

FIG. 24 is a graph of the perception aspects used in Example 3 for the sensory evaluation of soft serve product made from pre-mix of the present invention compared to soft serve product made from reference pre-mix. The soft serve product made from pre-mix of the present invention was perceived as a higher quality ice cream, indulging and fun to eat.

### Example 4: Visual Stability Evaluation of Soft Serve Product Made from Pre-Mix of the Present Invention Compared to Soft Serve Product Made from Reference Pre-Mix

Samples were prepared and received a day before and kept at 4° C. over-night before analyses. The same formulas, as detailed in Example 1, were used in Example 4. Sample 1 was the soft serve product made from the reference pre-mix. Sample 2 was the soft serve product made from pre-mix formulation of the present invention.

Both samples were left out at ambient temperature and a photograph of the sample was taken at time 0, 3 minute and 10 minute after poured from the soft serve machine.

FIG. 25 is a photograph of the soft serve made from reference pre-mix (Sample 1) of Example 4 at time 0. FIG. 26 is a photograph of the soft serve product made from reference pre-mix (Sample 1) of Example 4 at 3 minutes. FIG. 27 is a photograph of the soft serve product made from reference pre-mix (Sample 1) of Example 4 at 10 minutes. FIG. 28 is a photograph of the soft serve product made from pre-mix of the present invention (Sample 2) of Example 4 at time 0. FIG. 29 is a photograph of the soft serve product made from pre-mix of the present invention (Sample 2) of Example 4 at 3 minutes. FIG. 30 is a photograph of the soft serve product made from pre-mix of the present invention (Sample 2) of Example 4 at 10 minutes.

As can be seen from the photographs, Sample 2 showed excellent stability even at 10 minutes compared to Sample 1.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. A soft serve pre-mix composition comprising:
a) nutritional data comprising:
i) calories: 80-125 kcal/100 grams of composition;
ii) protein content: at least 3 grams/100 grams of composition;
iii) fat content: 0.5-3 grams/100 grams of composition;
iv) sugar content: 4-7 grams/100 grams of composition; and
v) dietary fiber content: 0.5-5 grams/100 grams of composition;
b) a formulation comprising:
i) a total sweetness index of between 13 to 20, wherein the sweetness index is calculated by:
total sweetness index=sum (Ingredient's Sweetness Intensity Factor of each ingredient having a measured sweetness index multiplied by the Total % of Formulation);
ii) 13-19% of bulking agents (net weight basis of total composition);
wherein the bulking agent is selected from the group of bulking agents consisting of polyols, glycerols, dietary fiber, maltodextrin and combinations thereof,
iii) 0.2-0.8% of pectin (wet weight of total composition);
iv) 8-13% of non-fat milk solids (“NFMS”) (wet weight of total composition);
c) wherein the taste profile of a soft serve made from the soft serve pre-mix composition has an overlapping taste profile when compared to a reference soft serve made from a soft serve pre-mix composition having the following properties:
i) nutritional data comprising:
A) fat content: 4.5 grams/100 grams of composition;
B) sugar content: 22 grams/100 grams of composition;
ii) a formulation comprising:
A) 73% milk (3% fat);
B) 6% cream (38% fat);
C) 4.5% skim milk powder;
D) 13% sucrose;
E) 3% glucose syrup (82%);
F) less than 1% stabilizers and emulsifiers; and
G) vanilla aroma.

2. The soft serve pre-mix composition of claim 1 wherein the composition includes a sweetening agent including at least one of (a) sucralose, (b) polyols, and (c) stevia, and wherein an amount of carbohydrates in the composition is 10-40 g/100 grams of composition.

3. A pre-mix composition that forms a soft serve product therein, the composition comprising: 72.0% to about 83.0% of milk, 0.1% to about 5.0% of a 38-40% cream, 2.5% to 5.0% of a (0.5% fat) skim milk powder, 0.002% to 0.005% sucralose, 4.0% to 14.0% maltitol, 1.5% to 5.0% maltitol syrup, 0.5% to 3.0% glycerol, 0.00% to 0.25% salt, 0% to 10.5% maltodextrin and starches, 0.0% to 2.5% FOS (such as inulin), 0.1% to 0.5% stabilizers, 0.05% to 0.35% MCC;
wherein, comprises the taste profile:
A) Sweetness (GL1) −70-(−80)
B) Bitterness (COO) −72-(−74)
C) Richness (CPA (AAE)) −13-(−16)
D) After-taste (AAE) −19-(−20); and (AE1) −18-(−20)
E) Saltiness (CTO) −5-(−7)
wherein, the taste profile is measured by the E-tongue test.

4. The pre-mix composition that forms the soft serve product therein of claim 1, wherein the soft serve product has superior stability, when exposed to ambient temperature for 10 minutes, as compared to a soft serve product made from the reference soft serve.
